(19) United States
(12) Patent Application Publication
(10) Pub. No.: US 2015/0303469 A1
(43) Pub. Date: Oct. 22, 2015

(54) COMPOSITE MATERIAL COMPRISING NANO-OBJECTS, IN PARTICULAR CARBON NANO-OBJECTS, PROCESS FOR PREPARING SAME, AND INK AND ELECTRODE COMPRISING THIS MATERIAL

(71) Applicant: COMMISSARIAT A L'ENERGIE ATOMIQUE ET AUX ENERGIE ALTERNATIVES, Paris (FR)

(72) Inventor: Pascal TIQUET, (US)

(73) Assignee: COMMISSARIAT A L'ENERGIE ATOMIQUE ET AUX ENERGIE ALTERNATIVES, Paris (FR)

(21) Appl. No.: 14/436,642

(22) PCT Filed: Oct. 17, 2013
(86) PCT No.: PCT/EP2013/071757

§ 371 Date: Apr. 17, 2015

(30) Foreign Application Priority Data
Oct. 19, 2012 (FR) 1260003

(51) Int. Cl. H01M 4/587; B01F 11/02; H01M 4/133; H01M 10/0525; C09D 11/52; C09D 105/04

(52) U.S. Cl. CPC H01M 4/587; C09D 11/52; C09D 105/04; H01M 4/133; H01M 10/0525; B01F 11/02; H01M 2004/027

(57) ABSTRACT

A nanocomposite material comprising nano-objects made of at least one first electron conducting material, such as carbon, and nano-objects or submicron objects made of at least one second material, such as silicon, different from the first material; said nanocomposite material comprising nanostructures each consisting of a three-dimensional network consisting of the nano-objects made of at least one first electron conducting material bound and maintained by a polysaccharide, the nano-objects or the submicron objects made of at least one second material different from the first material being self-assembled around said network and being attached to the nano-objects made of at least one first electron conducting material by said polysaccharide and said nanostructures being homogenously distributed in the material.

A method for preparing said nanocomposite material.

An ink comprising said composite material.

An electrode comprising as an electrochemically active material said composite material.

An electrochemical system, notably a lithium ion accumulator, comprising such an electrode.

### TECHNICAL FIELD

The invention relates to a composite material comprising nano-objects, notably carbon nano-objects.

More specifically, the invention relates to a composite material comprising carbon nano-objects and nano-objects of a material other than carbon such as silicon.

The material according to the invention may thus be designated as a nano-composite material.

The invention in particular relates to a composite material comprising carbon nanotubes (CNTs) and silicon nanoparticles.

The invention further relates to a method for preparing said composite material.

The invention also relates to an ink comprising the composite material according to the invention.

The composite material according to the invention, such as a silicon/carbon composite material may notably be used, after carbonization, as an electrochemically active material of an electrode, in particular of a negative electrode, in electrochemical systems with a non-aqueous organic electrolyte, such as rechargeable electrochemical accumulators with an organic electrolyte, notably in lithium batteries and still more specifically in lithium ion batteries.

The invention therefore also relates to an electrode, notably a negative electrode comprising this carbonized composite material as an electrochemically active material.

The invention finally relates to an electrochemical system, for example a lithium ion accumulator comprising such an electrode.

The technical field of the invention may generally be defined as that of composite materials comprising carbon and another material such as silicon.

### STATE OF THE PRIOR ART

The growth of the market of portable pieces of equipment has allowed the emergence of the lithium accumulator technology; and then the requirements specification for devices applying these accumulators has become increasingly restrictive. These devices always require more energy and autonomy, such that a decrease in the volume and in the weight of the accumulators is desired at the same time.

Lithium technology provides the best characteristics as compared with other present technologies. The lithium element is the most lightweight and the most reducing of metals and the electrochemical systems using the lithium technology may attain voltages of 4 V versus 1.5 V for the other systems.

Lithium ion batteries provide an energy density by mass of 200 Wh/kg versus 100 Wh/kg for NiMH technology, 30 Wh/kg for lead, and 50 Wh/kg for NiCd.

However, present materials and in particular active electrode materials attain their limits in terms of performances.

These active materials for electrodes are formed by an electrochemically active material which is a structure for reception, in which the cations, for example lithium cations, are inserted and de-inserted during cycling. The most commonly used negative electrode active material in lithium ion accumulators is graphite carbon, but its reversible capability is low and it has an irreversible capacity loss [symbol] ICL [symbol] .

Carbon nanotubes have been used as additives for active materials of a negative electrode or a positive electrode, or as an active material of an anode with view to improving the performances of lithium ion accumulators.

Thus, the document [1], LIU et al., “Carbon nanotube (CNT)-based composites as electrode material for rechargeable Li-ion batteries: A review”, Composites Science and Technology, 72 (2012), 121-144, describes nano-composite materials comprising single-wall carbon nanotubes and diverse cathode materials such as LiCoO₂, LiFePO₄, LiMn₂O₄, or further intrinsically conductive polymers.

This document further indicates that carbon nanotubes may be used as an anode material in the place of graphite, and describes anode nano-composite materials comprising single-wall carbon nanotubes and various anode active materials such as Sn; Bi; SnSb; CoSb₃; Ag, Fe, and Sn; TiO₂; SnO₂; Li₄Ti₅O₁₂; transition metal oxides such as TiO₂, Co₃O₄, CoO, and Fe₃O₄; and finally the silicon.

The accumulators which use the materials listed in document [1] still have insufficient performances.

Moreover, it is known that in the case of negative electrode active materials of Li ion technology, giving the possibility of improving the performances thereof, is to replace graphite with another material of better capacity such as tin or silicon.

With an estimated theoretical capacity of 3,579 mAh/g (for \Si→Li_{3.75}Si), silicon represents a desirable alternative to carbon as a negative electrode material. Nevertheless, this material has a major drawback preventing its use. Indeed, volume expansion of silicon particles which may reach 400% during charging upon insertion of lithium (Li-ion system), causes a degradation of the material with cracking of the particles and detachment of the latter from the current collector.

This embrittlement of the material is presently difficult to control and leads to low cyclability of the electrode.

It has been shown that by using these materials, such as silicon, as nanometric powders, it is possible to limit the extent of these degradation phenomena and to reach improved reversibility for capacities close to the theoretical values.

However, the use of silicon nanometric powders is rapidly confronted with problems for maintaining electron percolation within the electrode.

In order to provide a material capable of maintaining the integrity of the electrode after repeated charging-discharging cycles and of surmounting the problems inherent to silicon, many investigations have therefore, for several years, dealt with materials in which the alternative material, such as silicon, is coupled with carbon, these are in particular silicon/carbon composite materials in which generally, the silicon is dispersed in a carbon matrix.

The purpose of these materials is to combine the good cyclability of carbon with an additional contribution to capacity due to the adding of silicon.

However, accumulators such as lithium ion accumulators which comprise such materials again, there also, have insufficient performances.

Document CN-A-101,439,972 [2] describes particles of a silicon-carbon composite which comprises carbon nanotubes bound to silicon nanoparticles by amorphous carbon.

This composite material is prepared by a method comprising the following successive steps:
the silicon nanoparticles and the carbon nanotubes are dispersed in a solvent such as water or ethanol, in the presence of a dispersing agent;
the solvent and the dispersing agent are removed in order to thereby obtain particles of a composite material comprising silicon nanoparticles and carbon nanotubes;
the particles of this composite material are put into contact with a solution of an amorphous carbon precursor in an organic solvent;
the solvent of the precursor is removed and carbonization of the precursor is carried out by a chemical vapor deposition method (CVD).

The amorphous carbon precursor is an organic compound selected from resins, asphalts, sugars, benzene and naphthalene.

In this document, a simple statistical mixture of silicon nanoparticles and carbon nanotubes is produced, without there occurring a self-organization of the silicon nanoparticles around carbon nanotubes, because of this, the performances of lithium ion accumulators comprising the material prepared in this document are still insufficient.

Indeed, the statistical mixture is defined as an iso-probability of assembling a carbon nanotube (CNT) to a silicon particle (P_{CNT-Si}), or of assembling a silicon particle to a carbon nanotube (P_{Si-CNT}), or of assembling a silicon particle to a silicon particle (P_{Si—Si}), or of assembling a carbon nanotube to a carbon nanotube (P_{CNT-CNT}). The statistical mixture corresponds to equality of the assembling probabilities, i.e. P_{CNT-Si}˜P_{Si-CNT}˜P_{Si—Si}˜P_{CNT-CNT}.

The statistical mixture is not optimum, it does not allow generation of the [symbol] cluster [symbol] structure specific to the composite material according to the invention. In order to obtain the specific [symbol] cluster [symbol] structure of the material according to the invention, it is required that P_{Si-CNT}<<P_{CNT-CNT}>>P_{Si—Si}.

Further, the amorphous carbon content of the composite material prepared in this document is at least of the order of 24%, which is very high for a use as a negative electrode active material in lithium ion accumulators.

Finally, the method described in this document also has the drawback of using three organic molecules: one as a dispersant agent, one as an organic solvent and a last one as an amorphous carbon precursor.

Therefore considering the foregoing, a need exists for a nanocomposite material comprising nano-objects, notably a nanocomposite material comprising carbon nano-objects, in particular carbon nanotubes, and nano-objects of a material other than carbon, in particular silicon nanoparticles, which, when it is used as an electrochemically active material in an accumulator such as a lithium ion accumulator, gives the possibility of obtaining improved performances notably as to the discharge capacity of these accumulators.

Further, a need exists for such a material which may withstand the increases in volume during charging of the material other than carbon, such as silicon.

A need also exists for such a material, the amorphous carbon content of which is reduced.

Finally a need exists for a method for preparing such a material which is simple, reliable, includes a limited number of steps and also applies a restricted number of organic compounds.

The goal of the present invention inter alia is to meet these needs.

The goal of the present invention is notably to provide a nanocomposite material comprising nano-objects, notably a nanocomposite material comprising carbon nano-objects, such as carbon nanotubes and nano-objects of a material other than carbon, which does not have the drawbacks, defects, limitations and disadvantages of the nanocomposite material of the prior art, as notably illustrated by the documents studied above, and which solves the problems of the materials of the prior art.

The goal of the present invention is further to provide a method for preparing such a nanocomposite material which, similarly, does not have the drawbacks, defects, limitations and disadvantages of the methods for preparing nanocomposite materials of the prior art.

### DISCUSSION OF THE INVENTION

This goal, and further other ones, are achieved according to the invention by a nanocomposite material comprising nano-objects made of at least one first electron conducting material and nano-objects or submicron objects made of at least one second material different from the first material; said nanocomposite material comprising nanostructures each consisting of a three-dimensional network consisting of the nano-objects made of at least one first electron conducting material bound and maintained by a polysaccharide, the nano-objects or the submicron objects made of at least one second material different from the first material being self-assembled around said network and being attached to the nano-objects made of at least one first electron conducting material by said polysaccharide, and said nanostructures being homogenously distributed in the material.

By [symbol] nano-objects made of at least one first material [symbol] , is meant that the nano-objects consist of a single first material or of several first materials.

Also, by [symbol] nano-objects or submicron objects made of at least one second material [symbol] , are meant that these nano-objects or submicron objects consist of a single second material or of several second materials.

By [symbol] homogeneously distributed [symbol] , is generally meant that these nanostructures are distributed uniformly, regularly in the whole volume of the material and that their concentrations, presences, are substantially the same in the whole volume of the material.

It should be noted that the second material is not mandatorily an electron conducting material and this may often be an insulating material.

Advantageously, each of the nanostructures has a size which is at least equal to the size of each of the nano-objects made of at least one first electron conducting material, for example to the length of the carbon nanotubes.

Each of the nanostructures may thus have a size from 1 μm to 10 μm. The content of nano-objects made of at least one first electron conducting material and of nano-objects or submicron objects made of at least one second material different from the first material is 1% to 40%, and from 60% to 99% by mass, respectively.

Advantageously, the first electron conducting material is selected from carbon, metals such as aluminium and copper, and metal alloys such as alloys of aluminium and alloys of copper.

Advantageously, the second material may be selected from silicon; metals such as tin; metal alloys; sulfur, metal oxides such as alumina; positive electrode active materials of lithium ion accumulators such as LiFePO₄, LiFeSO₄F, LiCoO₂, LiNiO₂, LiFeₓMn_{y}PO₄, LiMnₓNi_{y}O₄, LiMnₓNi_{y}Nb_{z}O₄, LiNiₓMn_{y}Al_{z}O₂, LiCoₓNi_{y}Mn_{z}O₂, titanium phosphates, Li₂CoSiO₄, LiMnₓO₄, LiNiₓPO₄, LiCoₓO₂, LiNiₓCo_{y}O₂, sodium, vanadium oxide, TiS₂, TiOₓS_{z}, Li₂MnO₃; and the negative electrode active materials of lithium ion accumulators such as graphite, titanates like Li₄Ti₅O₁₂, H₂Ti₁₂O₂₅, Si, Sn, niobium oxides LiₓNb_{y}O_{z}, VBO₃, TiSnSb, Li₂SnO₃, Ni—Si, TiO₂, and SnCo.

Advantageously, the nano-objects made of at least one first material may be selected from nanotubes, nanowires, nanofibers, nanoparticles, nanocrystals made of at least one first material, and mixtures thereof; and the nano-objects or submicron objects made of at least one second material may be selected from nanotubes, nanowires, nanofibers, nanoparticles, submicron particles, nanocrystals made of at least one second material, and mixtures thereof.

In a first preferred embodiment, the first material is carbon, and the second material is a material other than carbon such as silicon.

Then, advantageously, in this first embodiment, the carbon nano-objects may be selected from carbon nanotubes, carbon nanowires, carbon nanofibers, carbon nanoparticles, carbon nanocrystals, carbon blacks, and mixtures thereof; and the nano-objects or submicron objects made of at least one material other than carbon may be selected from nanotubes, nanowires, nanofibers, nanoparticles, submicron particles, nanocrystals made of at least one material other than carbon, and mixtures thereof.

Preferably, the carbon nano-objects may be selected from carbon nanotubes and carbon nanofibers; and the nano-objects or submicron objects made of at least one material other than carbon may be nanoparticles or submicron particles of silicon.

The carbon nanotubes may be selected from single-walled carbon nanotubes, and multi-walled carbon nanotubes such as double-walled carbon nanotubes.

Advantageously, the nano-objects or the submicron objects made of at least one material other than carbon, such as silicon nanoparticles or silicon submicron particles, may have a spherical or spheroidal shape.

In a second embodiment, the first material is aluminium or copper, and the second material is a material other than aluminium or copper such as silicon.

Then, advantageously, in this second embodiment, the aluminium or copper nano-objects may be selected from aluminium or copper nanowires; and the nano-objects or submicron objects made of at least one material other than aluminium or copper may be selected from nanotubes, nanowires, nanofibers, nanoparticles, submicron particles, nanocrystals made of at least one material other than aluminium or copper such as silicon.

It should be noted that it is more advantageous to use carbon nanotubes which give the possibility of obtaining flexible three-dimensional networks ( [symbol] cooked spaghettis [symbol] ) while metal nanowires give rigid three-dimensional networks ( [symbol] knitting needles [symbol] ).

Advantageously, the ratio of the number of nano-objects or submicron objects made of at least one second material, for example made of silicon, to the number of nano-objects made of at least one first material, for example made of carbon, such as carbon nanotubes, is less than or equal to 1/100.

Advantageously, the polysaccharide may be selected from pectins, alginates, alginic acid and carrageenans.

Advantageously, the material according to the invention appears as a powder.

Generally, this power is an extremely airy, expanded, not very dense powder with a significant apparent bulk, volume, generally greater than 18 liter/kg of powder.

Advantageously, this powder has an average grain size, which generally corresponds to the average size of the nanostructures or bunches, comprised between 1 μm and 100 μm for example 20 μm, a specific surface area comprised between 10 m²/g and 50 m²/g, and a density comprised between 2.014 g/cm³ and 2.225 g/cm³.

The invention further relates to the material obtained by carbonization of the composite material as described above and transformation of the polysaccharide into amorphous carbon.

This carbonaceous material has an amorphous carbon content which is generally from 1% to 5% by mass, which is less than the amorphous carbon content of the material of document [2].

Additionally, the organization, specific structure, a so-called bunch of grapes, of the composite material according to the invention is retained in the carbonized material.

The composite material according to the invention has never been described or suggested in the prior art. The same applies to the material obtained by carbonization of the material according to the invention.

These materials fit the needs mentioned above and provide a solution to the problems of the materials of the prior art.

The composite material according to the invention has a very specific structure with a three-dimensional network formed by the nano-objects of the first material, such as carbon, bound and maintained by a polysaccharide, the nanoparticles of the second material, such as a material other than carbon, being self-assembled around said network and being attached to the nano-objects of the first material, such as carbon, by said polysaccharide.

Such a structure for a nanocomposite material based on nano-objects such as carbon nano-objects, for example carbon nanotubes, is totally novel.

The highly specific structure or organization of the material according to the invention may be defined as a [symbol] bunch of grapes [symbol] structure or organization in which the nano-objects made of a first material, such as carbon, for example carbon nanotubes, form a three-dimensional network or backbone around which the nano-objects made of a second material for example made of a material other than carbon, such as silicon nanoparticles will agglomerate, aggregate, self-assemble.

The nano-objects in a first material, for example the nano-objects in carbon such as CNTs form the branch and the peduncle of the bunch, while the nano-objects in a second material, for example in a second material other than carbon (in the case when the first material is carbon), such as silicon nanoparticles forming the grapes.

The nanocomposite material according to the invention fundamentally differs from the nanocomposite materials and notably from the silicon/carbon nanocomposite materials of the prior art in that in the material according to the invention, the nano-objects in a first material, for example the carbon nano-objects such as CNTs and the nano-objects in a second material, for example in a material other than carbon, such as silicon, are organized while in the materials of the prior art, the nano-objects are statistically distributed, at random.

In none of the materials of the prior art, is it possible to obtain a dispersion of the nano-objects as good with a distribution as regular as the latter.

Furthermore, in the material according to the invention, the organization of the nano-objects in a first material, for example carbon nano-objects, and nano-objects of a second material, for example of a material other than carbon, such as silicon, is a very particular organization, a so-called [symbol] bunch of grapes [symbol] organization wherein the nano-objects in a second material, such as a material other than carbon, are self-assembled around the nano-objects in a first material, for example carbon nano-objects, such as CNTs, which are used as an electron conducting backbone.

As compared with materials in which the nano-objects are not organized according to the invention with a specific grape bunch structure and are distributed statistically, at random, the material according to the invention has improved performances for example in a cycle, in fast charging, when it is applied in a lithium ion accumulator.

The polysaccharide contained in the material according to the invention notably ensures formation and retention of the structure, of the specific grape bunch organization of this material.

The polysaccharide actually plays several roles in the material according to the invention: it binds and maintains the nano-objects made of a first material, for example the carbon nano-objects, which thus make up a three-dimensional backbone or network, and it ensures self-assembling of the nano-objects made of a second material, for example made of a material other than carbon, such as silicon, around said network, and the attachment of these nanoparticles to the nano-objects made of a first material, such as carbon.

It may be stated that the polysaccharide structures the branches of the network of nano-objects made of a first material, for example carbon nano-objects, such as carbon nanotubes. The polysaccharide, first of all as a hydrogel, and then after freeze-drying, maintains the nano-objects, such as nanotubes, in an expanded network. In this network, nano-objects of the second material, for example of a material other than carbon, such as silicon nanoparticles are found.

Also it may be stated that the material according to the invention comprises an organized and connected network of nano-objects made of a first material, for example carbon nano-objects, such as carbon nanotubes [symbol] CNTs [symbol] , the connections between the nano-objects made of a first material, for example between the carbon nano-objects, being ensured by polysaccharide molecules such as an alginate.

It would seem that the nano-objects in a second material, for example in a material other than carbon, such as silicon nanoparticles for example, are adhesively bonded onto the nano-objects in a first material, for example on the carbon nano-objects such as CNTs, by the polysaccharide, while hydrogen bonds are formed between the hydroxyl groups at the surface of the nano-objects in a second material, for example in a material other than carbon, for example the silanol groups of silicon nanoparticles, and the OH groups of the polysaccharide, such as an alginate.

Indeed it is known that naturally, in contact with water, hydroxyl groups are formed, such as silanol groups at the surface of the nano-objects such as silicon nanoparticles.

In other words, the polysaccharide such as an alginate which allows good dispersion of the nano-objects in a first material, for example carbon nano-objects upon preparing the material, also allows self-assembling of nano-objects in a second material, and plays the role of a nanostructural [symbol] adhesive [symbol] which, when the material is used in a lithium ion accumulator, gives this material the required resistance to the electrolyte as well as to the swelling of the material other than carbon, such as silicon, which may exceed 240%.

The [symbol] bunch of grapes [symbol] structure, organization, of the material according to the invention, unlike materials in which the nano-objects are not organized in this way, gives the possibility of retaining the electron conduction and accessibility to the electrolyte, even when the nano-objects or submicron objects made of a second material, for example made of a material other than carbon, notably when these are silicon nanoparticles, have their volume increased.

The [symbol] bunch of grapes [symbol] structural organization of the material according to the invention, also gives the possibility of retaining the connectivity of the nano-objects or submicron objects made of at least one second material, for example made of a material other than carbon, such as silicon nanoparticles, to the electron conducting three-dimensional network. The organization of the material according to the invention is retained and is not modified upon individual increase in the volume of the nano-objects made of a second material, such as a material other than carbon (in the case when the first material is carbon), such as silicon nanoparticles.

The invention further relates to a method for preparing the nanocomposite material described above, wherein the following successive steps are carried out:

a) the nano-objects made of at least one first material are put into contact with water, and then the nano-objects made of at least one first material are mixed with water by using the succession, optionally repeated, of a mixing technique by ultrasound (with ultrasonic waves) and then of a high rate mixing technique, the mixture of nano-objects made of at least one first material and water being maintained in circulation, for example by means of a pump, such as a peristaltic pump, so as to avoid that the nano-objects made of at least one first material, agglomerate, whereby a dispersion consisting of the nano-objects made of at least one first material and of water is obtained, and said dispersion is maintained in circulation.

Indeed, this dispersion is an unstable mixture upon stopping the circulation, for example upon stopping the pump, such as a peristaltic pump, which conveys the mixture of nano-objects and of water from the device for applying the mixing technique with ultrasound, such as a disperser, mixer, with ultrasound, to the device for applying the high rate mixing;

b) without interrupting the circulation of the dispersion, the mixing by the ultrasound is stopped and the nano-objects or submicron objects made of at least one second material are mixed with the dispersion consisting of the nano-objects made of at least one first material and of water, by using a high rate mixing technique, whereby a dispersion consisting of the nano-objects made of at least one first material, of the nano-objects or submicron objects made of at least one second material, and of water, is obtained, and said dispersion is maintained in circulation;

c) without interrupting the circulation of the dispersion, at least one polysaccharide is added at a constant rate and is gradually dissolved in the dispersion consisting of the nano-objects made of at least one first material, the nano-objects or the submicron objects made of at least one second material, and water, and the polysaccharide is mixed with the dispersion by using a high rate mixing technique, whereby a dispersion is obtained in which nanostructures each consisting of a three-dimensional network consisting of the nano-objects made of at least one first material bound and maintained by a hydrogel of the polysaccharide, the nano-objects or the submicron objects made of at least one second material being self-assembled around said network and being attached to the nano-objects made of at least one first material by said hydrogel of the polysaccharide, are homogenously distributed;

d) the dispersion prepared in step c), is frozen, and then the ice is sublimated whereby the nanocomposite material according to the invention is obtained.

Advantageously, the concentration of the nano-objects made of a first material, such as carbon nano-objects, in the dispersion of step a) is from 1 to 5 g/l of water, for example 2.5 g/l of water.

Advantageously, during step a) the energy provided by the ultrasound does not exceed 5 joules.

Advantageously, the nano-objects or submicron objects made of at least one second material have a size from 50 nm to 800 nm.

Advantageously, the concentration of the nano-objects or of the submicron objects made of at least one second material in the dispersion of step b) is from 5 to 15 g/l of dispersion, for example 10 g/l of dispersion.

Advantageously, the concentration of the polysaccharide in the dispersion of step c) is from 1 to 6 g/l of dispersion.

The method according to the invention includes a specific sequence of specific steps which has never been described or suggested in the prior art and which allows preparation of the material according to the invention having the structure and the specific properties discussed above.

The method according to the invention includes a sequence of simple steps easy to apply.

The method according to the invention does not use any organic solvents since it applies water as a single solvent, more exactly as a dispersion liquid.

It does not use any additives, such as organic dispersants notably during step a) and b).

The single and unique organic compound applied in the method according to the invention is the polysaccharide, of which it may be considered that it plays to a certain extent the role of an additive for dispersion of the nano-objects such as carbon nanotubes CNTs. The polysaccharide also plays the role of an amorphous carbon precursor.

Thus, as compared with document [2], the method according to the invention uses a single type of organic molecule, the polysaccharide, instead of three.

Accordingly, the amorphous carbon content of the material obtained by carbonization of the material obtained at the end of step d) and by transformation of the polysaccharide into amorphous carbon is from 1% to 5% by mass, which is much less than the 24% minimum content of the material of document [2].

The invention further relates to an ink which comprises the composite material according to the invention, and a carrier, vehicle.

The carrier generally comprises at least one binder and at least one solvent.

Advantageously, the ink may further comprise at least one electron conductor.

This electron conductor may be selected from graphite, graphene, carbon fibers, and mixtures thereof.

The invention also relates to an electrode comprising as an electrochemically active material, the composite material according to the invention in which the polysaccharide has been carbonized and transformed into amorphous carbon.

This electrode inherently has all the advantageous properties related to the composite material which it contains as an electrochemically active material.

This electrode may be a positive electrode or a negative electrode.

The invention further relates to an electrochemical system comprising such an electrode.

This electrochemical system may be a system with a non-aqueous electrolyte such as a rechargeable electrochemical accumulator with a non-aqueous electrolyte.

Preferably, this electrochemical system is a lithium ion accumulator.

This electrochemical system such as a lithium ion accumulator inherently has all the advantageous properties related to the electrode which it contains.

### BRIEF DESCRIPTION OF THE DRAWINGS

The invention will be better understood upon reading the detailed description which follows, given as an illustration and not as a limitation with reference to the appended drawings wherein:

FIG. 1 is a schematic lateral sectional view of the mixing device used for dispersing the nano-objects in at least one first material like carbon nano-objects, such as carbon nanotubes.

Only a portion of this device, i.e. the high rate mixer, is retained for dispersing the other nano-objects such as silicon nanoparticles.

FIG. 2 is a graph which shows the dispersion state of the carbon nanotubes in the aqueous dispersion of carbon nanotubes, obtained at the end of the first step of the method according to the invention applying a mixing technique with ultrasound ( [symbol] US [symbol] ) and a high rate mixing technique (“Ultra-Turrax”).

In abscissas is plotted the diameter of the carbon nanotubes (in μm), and in ordinates is plotted the presence (in %) of the carbon nanotubes which have a given diameter.

FIG. 3 is a photograph taken with a scanning electron microscope (SEM) which shows the submicron silicon powder (diameter of about 310 nm) from S'Tile®.

The scale plotted in FIG. 3 represents 1 μm.

FIG. 4 is a graph which shows the characteristic curves of the grain size of dispersions of carbon nanotubes and of silicon particles obtained at the end of the second step (b) of the method according to the invention.

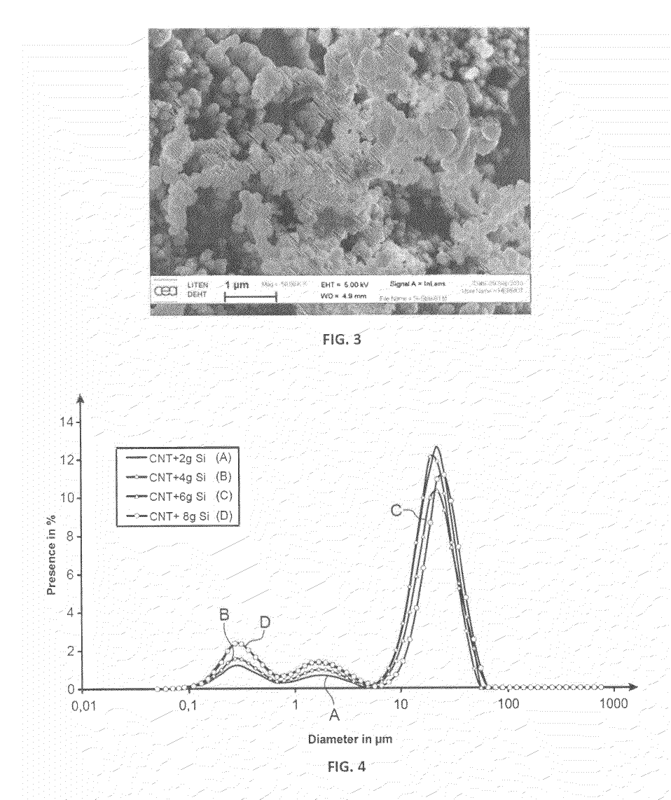

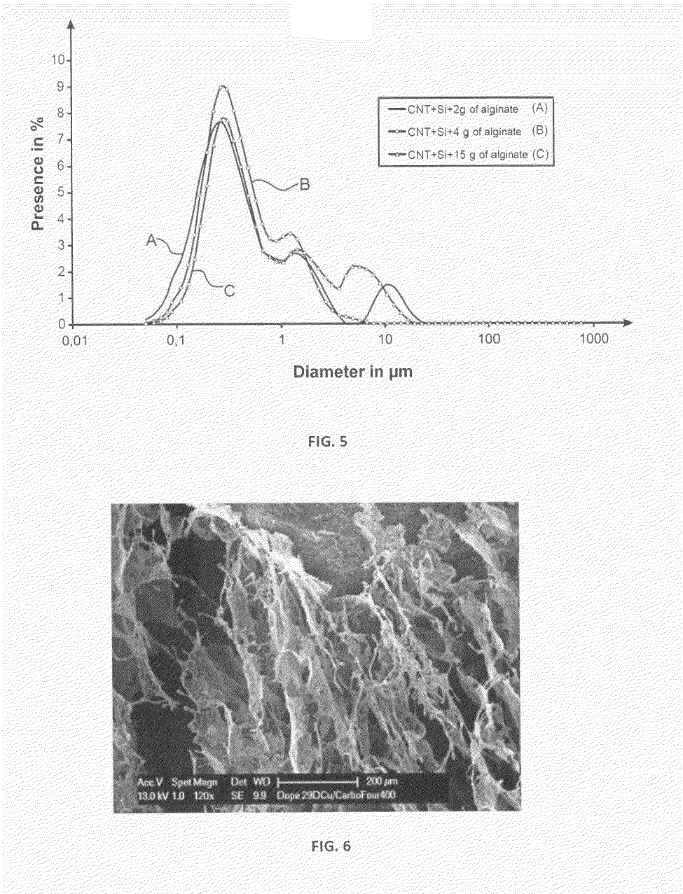

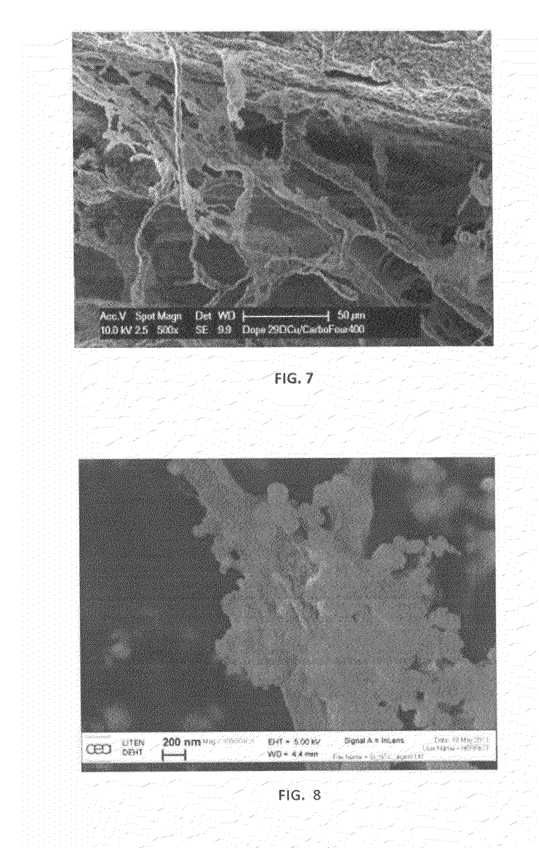

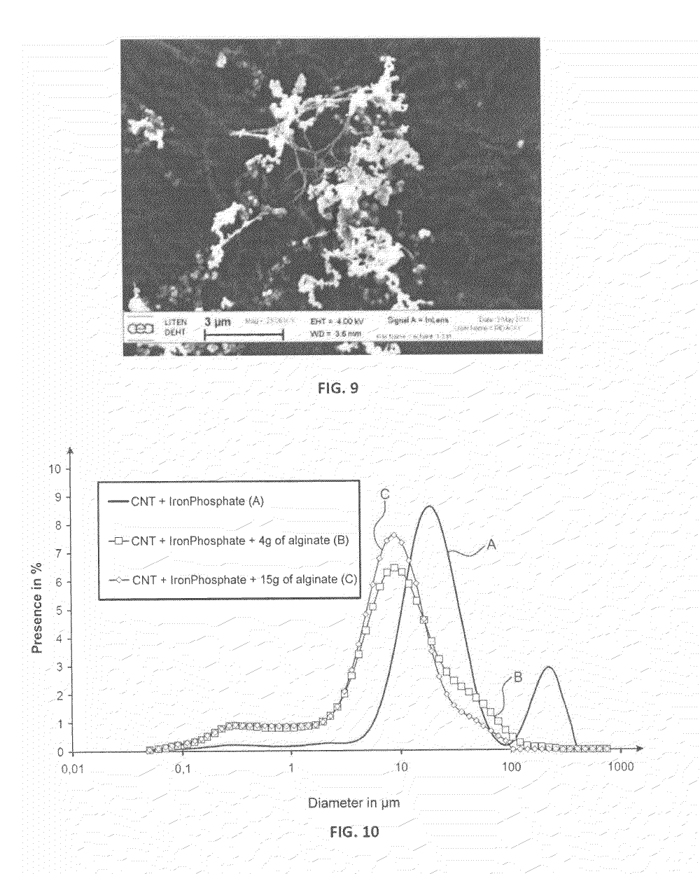

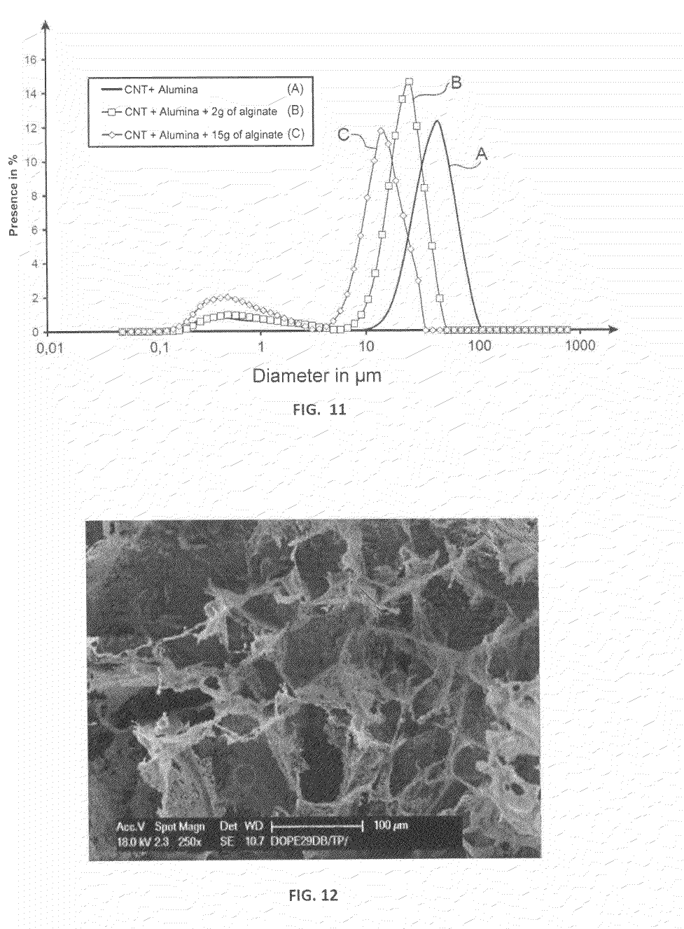

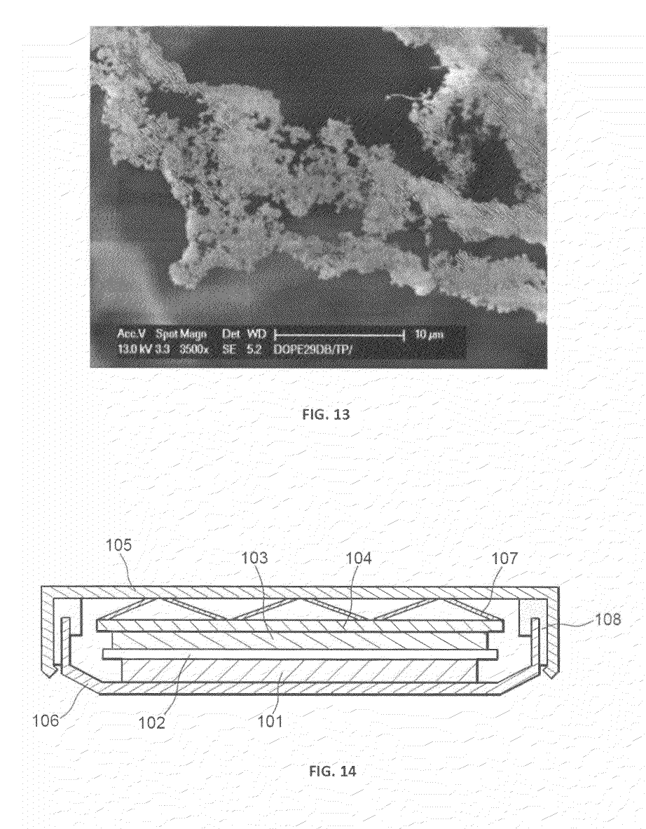

Curve A is the grain size curve of a dispersion of carbon nanotubes comprising 1.25 g of CNTs in 0.5 liter of water, i.e. a CNT concentration of 2.5 g/L, to which were added 2 g of silicon particles (FIG. 3), i.e. a silicon concentration of 4 g/L and a concentration of carbon nanotubes of 2.5 g/L.

Curve B is the grain size curve of a dispersion in water (0.5 L) of carbon nanotubes at a concentration of 2.5 g/L, to which were added 4 g of silicon particles (FIG. 3), i.e. a silicon concentration of 8 g/L.

Curve C is the grain size curve of a dispersion in water (0.5 L) of 1.25 g of carbon nanotubes, i.e. a concentration of carbon nanotubes of 2.5 g/L, to which were added 6 g of silicon particles (FIG. 3), i.e. a silicon concentration of 12 g/L.

Curve D is the grain size curve of a dispersion (0.5 L) of carbon nanotubes at 2.5 g/L, to which were added 8 g of silicon particles (FIG. 3), i.e. a silicon concentration of 16 g/L.

FIG. 5 is a graph which shows the characteristic curves of the grain size of dispersions of carbon nanotubes and of silicon particles as a [symbol] bunch of grapes [symbol] to which was added alginate obtained at the end of the third step of the method according to the invention.

Curve A is the grain size curve of a solution of one liter of water containing a dispersion in water of carbon nanotubes at 1.25 g/L, to which were added 8.75 g of silicon particles in a one liter solution in water, i.e. a silicon concentration of 8.75 g/L, and 2 g of alginate, i.e. an alginate concentration of 2 g/L.

Curve B is the grain size curve of a solution of one liter in water containing a dispersion in water of carbon nanotubes at 1.25 g/L, to which were added 8.75 g of silicon particles and 4 g of alginate, i.e. a silicon concentration of 8.75 g/L and an alginate concentration of 4 g/L.

Curve C is the grain size curve of a solution of one liter in water containing a dispersion in water of carbon nanotubes at 1.25 g/L, to which were added 8.75 g of silicon particles, i.e. a silicon concentration of 8.75 g/L and 7.5 g of alginate, i.e. an alginate concentration of 15 g/L.

FIGS. 6, 7, 8, and 9 are photographs taken with a scanning electron microscope (SEM), which shows the [symbol] bunch of grapes [symbol] self-assembly of silicon particles around the network of carbon nanotubes in a powder of a material according to the invention obtained after having frozen and freeze-dried a dispersion of carbon nanotubes and of silicon particles to which was added the alginate.

The scale plotted in FIG. 6 represents 200 μm.

The scale plotted in FIG. 7 represents 50 μm.

The scale plotted in FIG. 8 represents 200 nm.

The scale plotted in FIG. 9 represents 3 μm.

FIG. 10 is a graph which shows the characteristic curves of the grain size of a dispersion of carbon nanotubes and of lithiated iron phosphate (LiFePO₄) particles as a [symbol] bunch of grapes [symbol] obtained at the end of the second step of the method according to the invention, and of dispersions of carbon nanotubes and of lithiated iron phosphate (LiFePO₄) as a [symbol] bunch of grapes [symbol] to which was added the alginate, obtained at the end of the third step of the method according to the invention.

Curve A is the grain size curve of a solution of one liter in water containing a dispersion in water of carbon nanotubes at 2.5 g/L and of lithiated iron phosphate particles (LiFePO₄) at 8.75 g/L.

Curve B is the grain size curve of a solution of one liter in water containing a dispersion in water of carbon nanotubes at 2.5 g/L and of lithiated iron phosphate (LiFePO₄) at 8.75 g/L, to which were added 4 g of alginate, i.e. an alginate concentration of 4 g/L.

Curve C is the grain size curve of a solution of one liter in water containing a dispersion in water of carbon nanotubes at 2.5 g/L and of lithiated iron phosphate (LiFePO₄) particles at 8.75 g/L, to which were added 15 g of alginate, i.e. an alginate concentration of 15 g/L.

FIG. 11 is a graph which shows the characteristic curves of the grain size of a dispersion of carbon nanotubes and of alumina particles as a [symbol] bunch of grapes [symbol] obtained at the end of the second step of the method according to the invention, and of dispersions of carbon nanotubes and of alumina particles as a [symbol] bunch of grapes [symbol] to which was added the alginate, obtained at the end of the third step of the method according to the invention.

Curve A is the grain size curve of a solution of one liter in water containing a dispersion in water of carbon nanotubes at 2.5 g/L and of alumina particles at 8.75 g/L.

Curve B is the grain size curve of a solution of one liter in water containing a dispersion in water of carbon nanotubes at 2.5 g/L and of alumina particles at 8.75 g/L to which were added 2 g of alginate, i.e. an alginate concentration of 2 g/L of alginate.

Curve C is the grain size curve of a solution of one liter in water containing a dispersion in water of carbon nanotubes at 2.5 g/L and of alumina particles at 8.75 g/L, to which were added 15 g/L of alginate, i.e. a concentration of 15 g/L of alginate.

FIGS. 12 and 13 are photographs taken with a scanning electron microscope which show the structure of an electrode obtained from an ink prepared with the material according to the invention after plasma treatment.

The scale plotted in FIG. 12 represents 100 μm.

The scale plotted in FIG. 13 represents 10 μm.

FIG. 14 is a schematic lateral sectional view of an accumulator in the form of a button battery for example comprising a negative electrode to be tested according to the invention.

FIG. 15 is a graph which gives the specific capacity (in mAh/g) during discharging depending on the number of cycles (square markers ▪) during the test (Example 3) according to C/20 cycling of a button battery as illustrated in FIG. 14, the positive electrode of which consists of lithium metal and the negative electrode of which comprises as a negative electrode active material, a composite material according to the invention prepared in Example 1; as well as the specific capacity (in mAh/g) during discharging depending on the number of cycles during the test (Example 4) according to a C/20 cycling of a button battery as the one illustrated in FIG. 14, the positive electrode of which consists of lithium metal and the negative electrode of which comprises as a negative electrode active material, a material non-compliant with the invention (lozenge markers ♦) (see Example 4).

FIG. 16 is a photograph taken with a scanning electron microscope which shows the structure of an electrode according to the prior art prepared from a statistical dispersion of carbon nanotubes and of silicon nanoparticles.

The scale plotted in FIG. 16 represents 1 μm.

FIG. 17 is a photograph taken with a scanning electron microscope which shows the structure of an electrode according to the invention in which the carbon nanotubes and the silicon nanoparticles have a “bunch of grapes” organization.

The scale plotted in FIG. 17 represents 20 μm.

### DETAILED DISCUSSION OF PARTICULAR EMBODIMENTS

The detailed description which follows is rather made in connection with the method according to the invention for preparing a material according to the invention but it also contains teachings which apply to the materials according to the invention.

As a preamble to this detailed description, we first of all specify the definition of certain of the terms used herein.

By nano-objects, is generally meant any single object or bound to a nanostructure, at least one dimension of which is less than or equal to 500 nm, preferably less than or equal to 300 nm, still preferably less than or equal to 200 nm, better less than or equal to 100 nm, for example is in the range from 1 to 500 nm, preferably from 1 to 300 nm, still preferably from 1 to 200 nm, better from 1 to 100 nm, still better from 2 to 100 nm, or even from 5 to 100 nm.

These nano-objects may for example be nanoparticles, nanowires, nanofibers, nanocrystals or nanotubes.

By submicron object, is generally meant any object for which the size, such as the diameter in the case of a spherical or spheroidal object, is less than 1 μm, preferably is from 50 nm to 800 nm, for example 310 nm.

By nanostructure, is generally meant an architecture consisting of an assembly of nano-objects and/or submicron objects which are organized with a functional logic and which are structured in a space ranging from one cubic nanometer to one cubic micrometer.

By polysaccharide, is generally meant a polymeric organic macromolecule consisting of a chain of monosaccharide units. Such a macromolecule may be represented by a chemical formula of the form —[Cₓ(H₂O)_{y}]ₙ—.

As this is specified below, according to the invention, macromolecules consisting of mannuronic acid (M unit) and of guluronic acid (G unit) are preferably used.

The macromolecular chains which are the most suitable for the invention are those which maximize the M units (i.e. the M units/G units ratio is greater than 60%), since they retain via coordinations a larger amount of ions gelling the capsule.

This description generally refers more particularly to an embodiment in which the composite material prepared by the method according to the invention is the active material of a positive or negative electrode of a rechargeable lithium ion battery, but it is quite obvious that the description which follows may easily be extended and if necessary adapted to any application and to any embodiment of the composite material prepared by the method according to the invention.

In the description which follows, for the sake of simplification, a method for preparing a composite material comprising carbon nanotubes and nanoparticles or submicron particles of silicon is more particularly described but it will be understood that this description generally applies to the preparation of a composite material comprising nano-objects made of a first electron conducting material and nano-objects made of a second material different from the first material.

In the first step of the method according to the invention, carbon nano-objects such as carbon nanotubes (CNT) are dispersed in water. In other words, during this first step, carbon nano-objects are mixed with water.

The solvent of the thereby prepared dispersion is exclusively formed by water, excluding any other solvent. Generally, the water of the dispersion is deionized water (“DI” water).

Any additive is banned during this first step, and no additive whatever it is, is added to water, since in the obtained dispersion the carbon nanotubes must be [symbol] away from equilibrium [symbol] . This is the required condition for the [symbol] grape bunch [symbol] self-assembling according to the invention. It is only upon returning to equilibrium that the third step of the method according to the invention with the addition of a polysaccharide that this organization becomes possible.

The carbon nanotubes ( [symbol] CNT [symbol] ) may be single wall carbon nanotubes ( [symbol] SWCNT [symbol] ) or multi wall carbon nanotubes ( [symbol] MWCNT [symbol] ) such as double wall carbon nanotubes ( [symbol] DWCNT [symbol] ).

The carbon nanotubes may have an average length of 1 μm to 10 μm, for example 2 μm and an average diameter from 5 nm to 50 nm, for example 20 nm.

The concentration of the carbon nano-objects in the dispersion is generally from 1 to 5 g/L of water, for example 2.5 g/L of water.

Thus, the maximum concentration not to be exceeded is estimated to be 5 mg/ml of water for 10 μm tubes.

According to the invention, this first step for dispersing the carbon nano-objects, such as carbon nanotubes in water, may be achieved by adding the carbon nano-objects to water and then submitting the carbon nano-objects in water to a mixing, dispersion operation, combining two mixing techniques i.e., a mixing technique by ultrasound and then a mixing technique at a high rate.

Preferably, the ultrasound is generated by a probe placed in a container where are positioned the carbon nanotubes in water.

The ultrasonic waves generally have an acoustic power density from 1 to 1,000 W/cm², for example 90 W/cm² and the carbon nano-objects, such as the carbon nanotubes are exposed to the action of ultrasonic waves for a short duration, generally from 1 to 100 ms, for example 20 ms. Such a short duration gives the possibility of de-agglomerating the carbon nano-objects without breaking them and thereby avoiding damage to the carbon nano-objects.

By mixing at a high rate, is generally meant that the carbon nano-objects in water are accelerated and sheared with a shearing rate from 500 s⁻¹ to 2,000 s⁻¹ and that the velocity of the nano-objects is generally from 1 to 5 m/s, for example 3 m/s.

Such a velocity guarantees optimum de-agglomeration of the carbon nano-objects. Indeed, below 1 m/s and beyond 5 m/s, an agglomeration of the carbon nano-objects generally occurs.

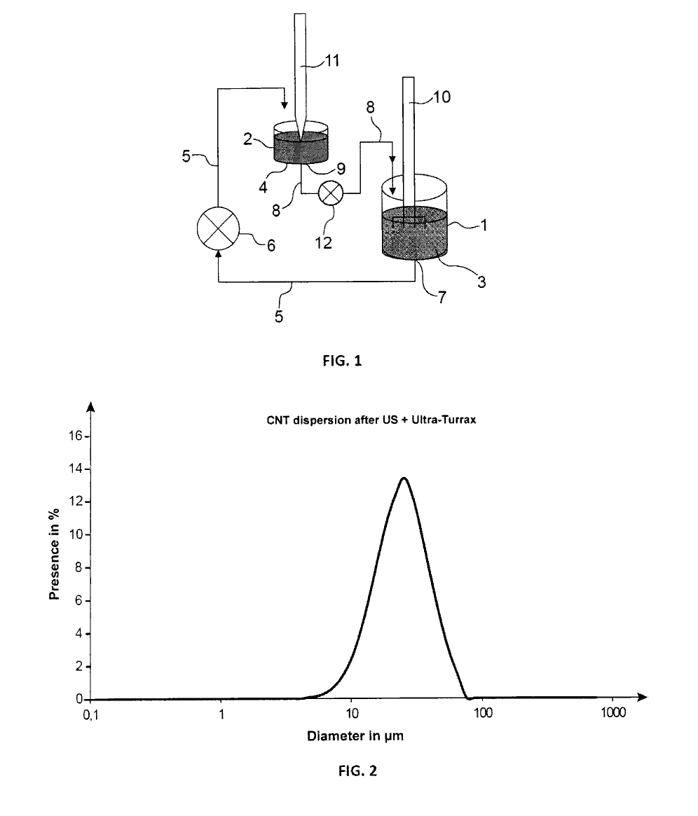

A device which may be applied for carrying out this step is illustrated in FIG. 1.

This device comprises a high rate mixing tank (1) and an ultrasound reactor (2) specific for this use. The high rate mixing tank (1) and the ultrasound reactor (2) appear as open cylindrical tanks with circular bases (3, 4).

A first duct (5), on which is placed a first pump, for example a peristaltic pump (6), connects an orifice (7) located at the centre of the base (3) of the high rate mixing tank (1) at the top of the ultrasound reactor (2).

A second duct (8), on which is placed a second pump (12), connects an orifice (9) located at the centre of the base (4) of the ultrasound reactor (2) to the top of the high rate mixing tank (1).

The diameter of the second duct (8) is for example 6 mm.

The flow rate inside this duct is estimated for example to be 17 m/min for a flow rate of more than 0.5 L/min.

It should be noted that, instead of using two pumps, a single two-way pump may be used, for example the pump (6) which is then placed on the duct (5) and on the duct (8).

The high rate tank (1) is equipped with a high rate stirrer (10), for example of the Ultra-Turrax® type.

The mixing technique is a hybridization of the technique with the ultrasonic technique with a probe.

The ultrasonic probe or rod (11) is placed at the centre of the ultrasound reactor (2) facing the orifice, an outlet (9) located at the centre of the base (4) of the ultrasound reactor (2).

In order to prepare the dispersion of nano-objects, one begins by positioning the water in the mixing tank without actuating the high velocity stirrer and then the carbon nano-objects are added, such as the carbon nanotubes, to the water. Or else, one begins by positioning the carbon nano-objects in the mixing tank without actuating the high rate stirrer, and then water is added to them.

A mixture of carbon nano-objects and water is thus formed.

Or else, the carbon nano-objects are pre-dispersed, mixed beforehand and then this pre-dispersion, this mixture is placed in the tank (1).

The mixture of water and of nano-objects for example consists of 1.25 g of carbon nano-objects, for example CNTs, in 500 ml of deionized water, i.e. the nano-object concentration of the mixture is 2.5 mg/ml.

The mixture of water and of nano-objects such as carbon nanotubes is conveyed via the duct (5) under the action of the pump (6) and arrives in the ultrasound reactor (2).

In the ultrasound reactor, the nano-objects are subject to exposure to ultrasonic waves emitted by the probe; for example they are subject to an exposure to ultrasonic waves with a frequency of 20 kHz and a power of 250 W for a short time, for example for about 20 ms, which corresponds to about 400 pulses.

This short exposure time to ultrasonic waves ensures that the carbon nano-objects such as CNTs are not damaged, and allows their de-agglomeration without breaking them since the energy applied generally does not exceed 5 joules.

The mixture of nano-objects and of carbon nano-objects which was exposed to ultrasonic waves is then set into motion by the peristaltic pump (12) in order to attain a linear velocity which is sufficient so that the nano-objects do not agglomerate again in the duct (8) after their passing into the reactor and their exposure to ultrasonic waves. This linear velocity is of at least 10 m/min, and may for example be 17 m/min.

After the ultrasound reactor (2), the nano-objects thus arrive via the duct (8) into the high-rate tank (1) where they are accelerated and sheared at a shear rate of 1,175 s⁻¹ for example.

There again, the nano-objects locally attain a velocity of generally 3 m/s which guarantees optimum de-agglomeration. Below 1 m/s and beyond 5 m/s, agglomeration of the nano-objects such as CNTs occurs.

This first step for preparing the aqueous dispersion by combining the ultrasound mixing technique and the high rate mixing technique generally lasts for 10 to 60 minutes, for example 30 minutes.

A typical dispersion state of the carbon nanotubes in the dispersion obtained at the end of this first step, is illustrated by the grain size curve of FIG. 2.

The system is characterized by the presence of agglomerates for which the size is comprised between 5 μm and 80 μm for example.

Therefore there always exist CNT agglomerates at the end of this step, which is surprising. The CNTs are not entirely in a network, but there exist interactions, connections, between these CNTs, and they surprisingly form agglomerates in which they are bound.

In other words, the water expands the CNT network but interactions between the CNTs are actually present.

The goal of the first step is not to obtain a perfect dispersion, since then the connections between the tubes no longer exist and the result is a statistical state of the CNT dispersion.

As this was specified above, the dispersion obtained at the end of the first step does not contain any solvent other than water and does not contain any additive for example of the dispersant type, such as sodium dodecyl sulfate (SDS), sodium dodecyl benzene sulfate (SDBS), lithium dodecyl sulfate (LDS), trimethyl ammonium bromide (TTAB), cetyltrimethyl ammonium bromide (CTAB), sodium deoxycholate (SC), sodium taurodeoxycholate (DOC), Igeal Co890®, Triton X-100® (C₈H₁₇C₆H₄(OC₂H₄)₉₋₁₀OH), and Tween® 20 and 80.

The obtained dispersion at the end of this first step consists therefore of carbon nanotubes and water, generally deionized water.

This dispersion is a dispersion [symbol] away from equilibrium [symbol] , only comprising a non-stable phase of CNTs and water, therefore it has to be maintained with stirring until the beginning of the second step and the stirring should not be stopped.

Generally, during all the transfers, the dispersion has always to be in motion, always have kinetic energy and have a sufficient linear velocity as already specified above.

Next, during the second step of the method according to the invention, nano-objects of another material such as silicon particles are mixed with the dispersion consisting of carbon nano-objects and of water obtained during the first step by only using a high rate mixing technique.

This second step of the method according to the invention may be applied with the device illustrated in FIG. 1, but in which only the high rate mixing tank equipped with a high rate stirrer, for example of the Ultra-Turrax® type is retained.

The ultrasonic waves are actually generally not desired during this step since they notably promote the reaction of oxidation of silicon with water with production of hydrogen.

The system operates in a closed loop, i.e. the orifice located at the centre of the base of the high rate mixing tank is connected to the pump, which re-injects the solution into the high rate mixing tank.

This pump sets into motion the aqueous dispersion of carbon nanotubes and of silicon particles from the high rate mixing tank so that it acquires and retains a linear velocity which is sufficient so that the carbon nanotubes do not again agglomerate in the duct. This linear velocity may for example be 17 m/min so as to avoid re-agglomeration and local rearrangement corresponding to a flow rate of more than 0.5 L/min.

The high rate mixing conditions have already been mentioned above, this is a shear rate of a 1,175 s⁻¹ for example, with a fluid propelled at a [symbol] high [symbol] velocity from 1 m/s to 5 m/s, for example 3 m/s.

The amount of silicon particles is such that the dispersion of carbon nanotubes and of silicon particles, obtained generally contain from 5 to 15 g, for example 9 g of silicon particles/L of dispersion.

Indeed, beyond 15 g of silicon particles/L of dispersion, self-assembling is generally no longer possible since the number of silicon particles is too large with respect to the number of carbon nanotubes. The same applies below 5 g of silicon particles/L of dispersion.

The ratio of the number of silicon particles/number of carbon nanotubes should generally not be greater than 1/100. This value of 1/100 is generally the upper limit beyond which it is no longer possible to obtain the desired [symbol] grape bunch [symbol] structure.

The silicon particles are generally added at a constant rate, generally in an amount from 10 to 500 mg/min, for example in an amount of 300 mg/min. Thus, if 9 g of silicon are added, the duration of the addition will generally be 30 minutes.

The silicon particles are generally submicron particles, i.e. for which the size such as the diameter is less than 1 μm, for example from 50 nm to 800 nm, for example again 310 nm.

A spherical shape of the silicon particles is recommended for allowing easy insertion of these silicon particles into the entanglement network of carbon nanotubes.

A silicon powder which is particularly well suited for a use in the method according to the invention is a submicron spherical silicon powder, the particles of which have a diameter of about 310 nm and which is available at S'tile (FIG. 3).

During this step, the last [symbol] bundles [symbol] of carbon nanotubes are abraded and the most entangled carbon nanotubes are extracted therefrom by the high velocity used and by the application of a submicron silicon powder which may thus infiltrate the entanglement network of the carbon nanotubes.

The duration of this step during which the conditions discussed above are maintained, i.e. inter alia, the addition of silicon particles at a constant rate, the shear rate, and the high velocity of the fluid is generally from 15 to 60 minutes, for example 30 minutes.

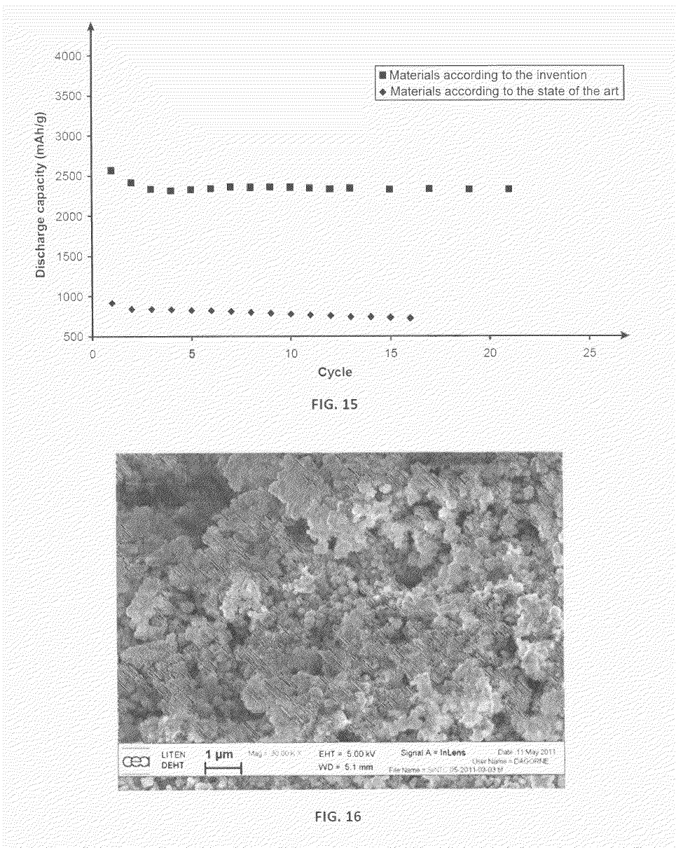

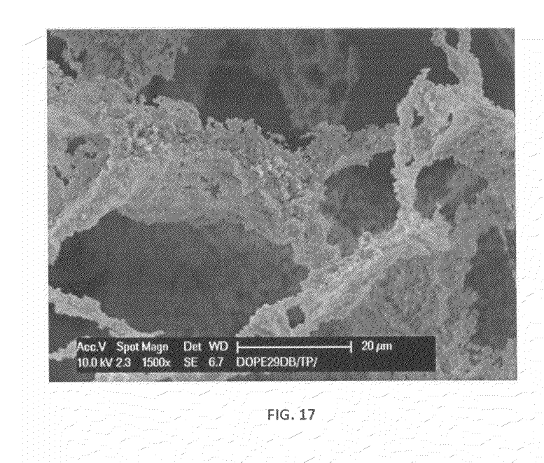

At the end of this second step of the method according to the invention, the aqueous dispersion of carbon nanotubes and of silicon particles, obtained, is tri-modal and has the grain size characteristics illustrated in FIG. 4, in which the existence of three populations may be noted.

The first population, between 100 nm and 700 nm, in majority consists of individual silicon particles.

The second population, between 5 μm and 60 μm, consists of swollen CNTs constituting macro-agglomerates.

The third population, between 700 nm and 5 μm, consists of a mixture of individual CNTs and micro-agglomerates.

At the end of this second step, the CNTs still form agglomerates, but this is rather an entangled network of CNTs and not of compact bundles.

The third step of the method according to the invention consists of adding at a constant rate and of gradually dissolving macromolecules of at least one polysaccharide such as an alginate into the dispersion consisting of the carbon nanotubes, the silicon particles and water, and then mixing the macromolecules with the dispersion by using a high rate mixing technique.

There is no limitation as to the polysaccharide macromolecule and all molecules belonging to the family of polysaccharides may be used in the method according to the invention. These may be natural or synthetic polysaccharides.

The polysaccharide macromolecule may be selected from pectins, alginates, alginic acid and carrageenans.

By alginates, is meant both alginic acid and salts and derivatives thereof such as sodium alginate. The alginates, notably sodium alginate are extracted from various brown algae Phaeophyceae, mainly Laminaria such as Laminaria hyperborea; and Macrocystis such as Macrocystis pyrifera. Sodium alginate is the most common marketed form of alginic acid.

Alginic acid is a natural polymer of empirical formula (C₆H₇NaO₆)ₙ consisting of two monosaccharide units: D-mannuronic acid (M) and L-guluronic acid (G). The number of base units of alginates is generally of about 200. The proportion of mannuronic acid and of guluronic acid varies from one species of algae to the other and the number of units M over the number of units G may range from 0.5 to 1.5, preferably from 1 to 1.5.

Alginates are linear non-branched polymers and are not generally random copolymers but depending on the algae from which they are derived, they consist of sequences of similar or alternating units, i.e. sequences GGGGGGGG, MMMMMMMM, or GMGMGMGM.

For example, the M/G ratio of the alginate derived from Macrocystis pyrifera is of about 1.6 while the M/G ratio of the alginate derived from Laminaria hyperborea is of about 0.45.

Among the polysaccharide alginates derived from Laminaria hyperborea, mention may be made of Satialgine SG 500, from among the polysaccharide alginates derived from Macrocystiis pyrifera with different molecule lengths, mention may be made of the polysaccharides designated as A7128, A2033 and A2158 which are generics of alginic acids.

The polysaccharide macromolecule applied according to the invention generally has a molecular weight from 80,000 g/mol to 500,000 g/mol, preferably from 80,000 g/mol to 450,000 g/mol.

The added polysaccharide amount is such that the obtained dispersion generally contains from 1 g to 6 g of polysaccharide/L of dispersion.

Indeed, beyond 6 g of polysaccharide/L of dispersion, the polysaccharide such as an alginate is no longer used for self-assembling but only for coating the “bunch of grapes” nanostructure.

Therefore it is not generally necessary to use greater concentrations beyond 6 g of polysaccharide/L of dispersion.

Also, below 1 g of polysaccharide/L of dispersion, self-assembling cannot occur.

The polysaccharide is generally added at a constant rate, generally in an amount from 10 to 500 mg/min, for example in an amount of 100 mg/min.

In order to achieve such an addition at constant rate, it is possible for example to use a vibrating belt so as to perfectly control the amount and the distribution of the polysaccharide particles, for example alginate powder particles added to the dispersion.

The dissolution of the polysaccharide, such as the alginate is then achieved gradually, without there occurring any agglomeration of these polysaccharide particles upon contact with water.

This gradual dissolution in a controlled way gives the possibility of obtaining the self-assembling according to the invention as a so-called [symbol] bunch of grapes [symbol] , of silicon particles on the backbone of carbon nanotubes.

In the dispersion obtained at the end of this step, the carbon nanotubes are bound and maintained by the polysaccharides such as the alginate and thereby form a backbone or three-dimensional network of CNTs.

The silicon nanoparticles are bound to the alginate via hydrogen bonds, and the silicon nanoparticles are adhered to the backbone of CNTs by means of the alginate.

FIG. 5 shows the grain size curves characteristic of the dispersions of carbon nanotubes and of silicon particles as a “bunch of grapes” to which the alginate was added, obtained at the end of the third step of the method according to the invention.

FIG. 5 shows that the CNTs have globally disappeared in the structure. Indeed, there only exists a small residual peak at 10 μm corresponding to residues of CNT agglomerates.

During the next step, which is the fourth step of the method according to the invention, the dispersion of carbon nanotubes and of silicon particles to which was added a polysaccharide such as an alginate, prepared in the third step, is frozen and freeze-dried.

In order to retain the organization according to the invention, the dispersion is then freeze-dried i.e. it is successively frozen, solidified, and then sublimated.

For this, the dispersion may be poured drop wise directly into liquid nitrogen in order to obtain frozen macro-objects or capsules preferably having a spherical shape and the size of which, such as the diameter, is for example from 5 mm to 20 mm.

The size of the macro-objects made is of little importance on the internal organization of the “grape bunch” nanostructure.

The size of the macro-objects only influences the rapidity and the quality of the freeze-drying.

Instantaneous solidification of the drops upon contact with liquid nitrogen minimizes sorting out of the solvent, i.e. water, capsules, thereby maintaining a maximum dispersion of the grape structures in the capsule and retaining the “grape bunch” structure obtained earlier in the dispersion.

This solidification, freezing, in fact is the first portion of the freeze-drying treatment. The frozen macro-objects, capsules may be optionally stored in a freezer before proceeding with sublimation and optional subsequent treatments.

This solidification, freezing of the dispersion in order to obtain macro-objects, is followed by a sublimation step which constitutes the second part of the freeze-drying treatment.

During this sublimation step, under the effect of vacuum, the frozen solvent, i.e. ice, is removed inside the macro-objects or capsules.

Freeze-drying is generally carried out under a high vacuum, i.e. under a pressure not exceeding 5.10⁻³ mbars, for example a pressure from 10⁻³ to 10⁻⁷ mbars and at a temperature not exceeding −20° C., for example a temperature of −80° C.

The duration of the freeze-drying depends on the equipment used and may range for example from 1 h to 12 h per liter of dispersion.

Optionally, the freeze-drying treatment may comprise a third part during which the agglomerates are cold dried.

It should be noted that this freeze-drying step may be carried out even if the first solvent does not comprise any polymer or monomer and/or if the gelled agglomerates are not impregnated in a third step by a polymer or a monomer, notably water-soluble.

The freeze-drying may be carried out regardless of the solvent of the gelled agglomerates whether this is water or any other solvent or mixture of solvents. Generally, it is, however, necessary that the solvent of the gelled agglomerates contains in majority water.

At the end of the freeze-drying, there is substantially no more water in the freeze-dried macro-objects. The water content of the freeze-dried macro-objects, capsules is generally less than 0.01% by mass.

The specific organisation as a [symbol] bunch of grapes [symbol] of the nano-objects, such as CNTs and silicon nanoparticles, which had been obtained in the dispersion of nano-objects is retained in the freeze-dried macro-objects, capsules, as this is seen in FIGS. 6, 7, 8, and 9 where it is observed that silicon nanoparticles are aggregated, self-assembled around a network of CNTs.

The chemical nature of the material other than carbon for example as a submicron powder has no influence on the self-assembling mechanism.

The method was tested with alumina, LiFePO₄ and the curves of FIG. 10 and of FIG. 11 show that the self-assembling technique as a [symbol] bunch of grapes [symbol] may be generalized to any material, for example as a submicron powder regardless of the chemical nature of this material such as for example sulfur, tin, spinelle structures and cobalt etc.

In fact, the freeze-dried macro-objects, capsules consist of an expansed powder for which the grains are loosely assembled and thereby form said macro-objects or capsules.

The self-assembled [symbol] bunch of grapes [symbol] powder thereby prepared after freeze-drying, is ready to use for any subsequent use, for example for making an ink and does not require any milling which would break any organization present in the powder.

The grain size of the self-assembled powder as a [symbol] bunch of grapes [symbol] is generally comprised between 1 μm and 100 μm, its specific surface area is generally comprised between 10 m²/g and 50 m²/g, and its density is generally comprised between 2.014 g/cm³ and 2.225 g/cm³.

The freeze-dried macro-objects may then be mixed, for example by simple mechanical action with any kinds of materials.

This mechanical action may comprise one or several operations for example, it is possible to only carry out an extrusion; or else it is possible to carry out simple mechanical mixing; or else it is possible to carry out a simple mechanical mixing optionally followed by drying of the mixture.

The specific organization according to the invention, as a [symbol] bunch of grapes [symbol] of the carbon nano-objects and of the nano-objects in another material, such as CNTs and silicon nanoparticles, is retained after this mechanical action.

For example in the case when it is desired to prepare an ink or a paste, slurry containing the composite material according to the invention, the latter is mixed with the materials which form the carrier, vehicle of this ink or paste, slurry.

By carrier, vehicle of an ink or paste, slurry, are generally meant the components, ingredients required for giving to this ink or paste, slurry and to the marking obtained with this ink or paste, slurry, the desired properties.

The carrier, vehicle of the ink or paste, slurry generally comprises a binder and a solvent.

The carrier, vehicle may further comprise at least one electron conductor different from the composite material according to the invention.

There is no limitation on the ink, in which may be incorporated the composite material according to the invention, notably there exists no limitation as regards the carrier, vehicle, the binder and the solvent with which the material according to the invention may be mixed for preparing an ink or paste, slurry.

The ink may be an ink based on water, i.e. the solvent of which comprises in majority water or consists of water; an ink based on an organic material, i.e. the solvent of which in majority comprises one or several organic solvents or consists of one or several organic solvents for example a so called fatty-based ink, the solvent of which consists of one or several drying oils; an ink based on a silica or carbon gel-sol.

The binder may be selected from organic polymers such as photo-cross-linkable polymers such as acrylic polymers, heliographic resins, photo-lithographic resins, cross-linkable thermosetting polymers such as epoxides, natural polymers such as the polysaccharides already mentioned above like alginates.

Preferably, the solvent is water and the binder is a polysaccharide such as an alginate.

Still preferably, the binder is the same polysaccharide as the one of the nanocomposite material according to the invention.

As the organization of the nanopowders of the composite material is produced upstream from the making of the ink, it becomes possible to use any binder, notably an organic binder as a binder for this ink and for the electrode prepared from the latter.

This ink or paste, slurry is generally intended for preparing an electrode by coating, printing, depositing, by means of a printing device, said ink or paste, slurry on a current collector.

Indeed, the composite material according to the invention in which the polysaccharide has been carbonized and transformed into amorphous carbon may be used as an electrochemically active electrode material in any electrochemical system.

More specifically, the composite material prepared according to the invention may notably be used after carbonization and transformation of the polysaccharide into amorphous carbon, as an electrochemically active positive or negative electrode material in any electrochemical system in particular in any electrochemical system with a non-aqueous electrolyte.

This positive or negative electrode comprises, in addition to the electrochemically active material of a positive or negative electrode as defined above, a binder which is generally an organic polymer, optionally electron conducting additive(s), and a current collector.

Some of the organic polymers which may be used for the binder have already been mentioned above.

The organic polymer may also be selected from polytetrafluoroethylene (PTFE), poly(vinylidene fluoride) (PVDF), PVDF-HFP (propylene-hexafluoride) copolymer; carboxymethylcellulose; and elastomers such as CMC-SBR (carboxymethylcellulose-styrene butadiene rubber).

Preferably, the binder is a polysaccharide such as an alginate.

Still preferably, the binder is the same polysaccharide, such as an alginate, as the one of the nanocomposite material according to the invention.

The optional electron conducting additive may be selected from metal particles such as Ag particles, graphite, graphene, carbon black, carbon fibers, carbon nanowires, carbon nanotubes and electron conducting polymers, and their mixtures.

Indeed, graphene and carbon fibers may exactly fulfill the same role as the graphite in the ink.

Only the large scale organization will be different depending on the nature of the contemplated electron conductor like carbon fibers or micrometric graphite.

The current collector generally appears as a copper, nickel or aluminium sheet.

The electrode generally comprises from 70% to 94% by mass of electrochemically active material, from 1% to 20% by mass, preferably from 1% to 10% by mass of binder, and optionally from 1% to 15% by mass of the electron conducting additive(s).

Such an electrode may be prepared conventionally by forming, as described above, a suspension, slurry, paste or ink with the composite material according to the invention, the binder, optionally the conductive additive(s) and a solvent, by depositing, coating or printing this suspension, slurry or ink on a current collector, by drying the deposited ink, slurry or suspension by calendering, pressing the deposited, dried ink or slurry and the current collector, and finally by heat treating the electrode in order to carbonize the polysaccharide, such as an alginate and to transform it into amorphous carbon.

In order to form a suspension, slurry or ink, the material according to the invention, generally as an expansed powder as described above is incorporated into the carrier of the ink, i.e. a mixture of the binder, of the solvent and of the optional conductive additives.

Preferably, the solvent and the binder appear as an aqueous gel of polysaccharide, such as an alginate hydrogel.

The incorporation of the material according to the invention into this mixture is preferably carried out by a mixing technique without any milling, in a mixing device not causing any milling, and applying very little energy, i.e. generally less than 100 joules/revolution, in order to preserve the self-assembly of the carbon nanotubes with the silicon nanoparticles which is preserved at 60 J/revolution.

Such a mixing device gives the possibility of avoiding lumps, and gives the possibility of retaining an ink fineness of less than 10 μm.

Therefore it is possible with this technique and this device, to intimately mix the self-assembled powder of carbon nanotubes and of silicon nanoparticles with its carrier, such as an alginate hydrogel, by adjusting the viscosity with water so as to attain for example the value of 1 Pa·s at a shear rate of 1 s⁻¹ and a grain size fineness of less than 10 μm.

The ink, slurry or suspension may be applied by any adequate method such as coating, layer deposition, rotogravure, flexography, offset printing.

The applied deposited ink, slurry or suspension thickness is generally from 50 to 300 μm, for example 100 μm.

The deposited ink, slurry or suspension is generally dried at room temperature i.e. from 15° C. to 30° C., preferably 20° C.

The heat treatment of the electrode in order to carbonize the polysaccharide, such as an alginate, and to transform it into amorphous carbon is generally carried out at a temperature from 400° C. to 650° C., for example 600° C., for a period from 15 to 60 minutes, for example 30 minutes with inert gas sweeping such as argon or with a slightly reducing gas sweeping, such as a mixer of an inert gas like argon and of a reducing gas like hydrogen, with a mixture of argon and hydrogen (for example with 2% by volume of hydrogen).

Beforehand, two primary vacuum cycles are carried out for removing the oxygen and the water from the material.

The mass loss does not generally exceed 30%, which is a low value guaranteeing good cohesion of the electrode and good adherence to the current collector, for example to the copper sheet forming this current collector.

These electrodes are then cut out into discs, and these discs may then be treated with a hydrogen plasma in order to de-oxide the silicon when the composite material comprises it and etching the amorphous carbon in order to improve accessibility of the electrolyte to the surfaces of the silicon nanoparticles.

The structure of the electrode after the plasma treatment is shown on the photographic plates of FIGS. 12 and 13.

It is noted that the [symbol] grape bunch [symbol] organization is retained after the plasma treatment.

The electrochemical system in which the electrode according to the invention is applied, may notably be a rechargeable electrochemical accumulator with a non-aqueous electrolyte such as a lithium accumulator or battery, or more particularly a lithium ion accumulator, which in addition to the positive or negative electrode as defined above, comprising as an electrochemically active material, the composite material prepared according to the invention in which the polysaccharide has been carbonized and transformed into amorphous carbon, comprises a negative or positive electrode which does not comprise the composite material according to the invention, and a non-aqueous electrolyte.

The negative or positive electrode, which does not comprise an electrochemically active material, the composite material according to the invention in which the polysaccharide has been carbonized, comprises a different electrochemically active material from the composite material according to the invention, a binder, optionally one or several electron conductive additives and a current collector.

The binder and the optional electron conductive additive(s) have already been described above.

The electrochemically active material of the negative or positive electrode which does not comprise the composite material according to the invention in which the polysaccharide has been carbonized as an electrochemically active material may be selected from all the materials known to the man skilled in the art.

Thus, when the composite material according to the invention in which the polysaccharide has been carbonized is the electrochemically active material of the negative electrode, then the electrochemically active material of the positive electrode may be selected from lithium metal or any material known to the man skilled in the art in this technical field.

When the electrochemically active material of the positive electrode is formed by the material according to the invention in which the polysaccharide has been carbonized, the electrochemically active material of the negative electrode may be made of any material known and adaptable by the man skilled in the art.

The electrolyte may be solid or liquid.

When the electrolyte is liquid, it consists for example of a solution of at least one conductive salt such as a lithium salt in an organic solvent and/or an ionic liquid.

When the electrolyte is solid, it comprises a polymeric material and a lithium salt.

The lithium salt may be for example selected from LiAsF₆, LiClO₄, LiBF₄, LiPF₆, LiBOB, LiODBF, LiB(C₆H₅), LiCF₃SO₃, LiN(CF₃SO₂)₂ (LiTFSI), LiC(CF₃SO₂)₃ (LiTFSM).

The organic solvent is preferably a solvent compatible with the constituents of the electrodes, relatively not very volatile, aprotic and relatively polar. Mention may for example be made of ethers, esters and mixtures thereof.

The ethers are notably selected from linear carbonates such as dimethyl carbonate (DMC), diethyl carbonate (DEC), methylethyl carbonate (EMC), dipropyl carbonate (DPC), cyclic carbonates like propylene carbonate (PC), ethylene carbonate (EC) and butylene carbonate; alkyl esters like formates, acetates, propionates and butyrates; gamma-butyrolactone, triglyme, tetraglyme, lactone, dimethylsulfoxide, dioxolane, sulfolane and mixtures thereof. The solvents are preferentially mixtures including EC/DMC, EC/DEC, EC/DPC and EC/DMC.

The accumulator may notably have the shape of a button battery.

The different elements of a button battery, in stainless steel 316L are described in FIG. 14.

These elements are the following:
the upper (105) and lower (106) portions of the stainless steel casing,
the polypropylene gasket (108),
the stainless steel shims (104), which are for example both used for cutting out the lithium metal and then later on for ensuring good contact of the current collectors with the external portions of the battery,
a spring (107), which ensures the contact between all the elements,
a microporous separator (102) impregnated with electrolyte,
electrodes (101) (103).

The invention will now be described with reference to the following examples given as an illustration and not as a limitation.

### EXAMPLES

### Example 1

In this example, a composite material of silicon nanoparticles/carbon nanotubes according to the invention is prepared by the method according to the invention as it has been described above.

This composite material appears as a self-assembled powder having the characteristic “bunch of grapes” structure of the material according to the invention.

1.25 g of carbon nanotubes are weighed and poured into 500 ml of de-ionized water, in a 2 liter beaker.

The nanotubes are nanotubes of the Graphistrength® brand available from Arkema®. These are multi-wall nanotubes with a purity of more than 90%, with an average diameter between 10 nm and 15 nm, and an average length of 7 μm. The specific surface area of these nanotubes is comprised between 20 m²/g and 70 m²/g.

The initial grain size is comprised between 10 μm and 100 μm in majority as entangled nanotubes and forming agglomerated balls.

The beaker is placed under a high rate disperser of the Ultra-Turrax® type adjusted to 2,000 rpm.

Silicone pipes are then used for connecting the beaker to the inlet of an ultrasound reactor by passing through the first route of a peristaltic pump (which includes two ways), and for connecting the outlet of the reactor to the beaker via the second way of the peristaltic pump.

The peristaltic pump is adjusted to 200 rpm which amounts to a circulation rate of 0.77 liters/min of solution of CNTs.

The mixing duration is 30 minutes.

The pump and the ultrasound system are stopped, and only the high rate stirring is maintained at 2,000 rpm.

8.75 g of silicone are then added to the solution or rather to the dispersion at a rate of 250 mg/min.

The silicone is in the form of a powder available from S'tile.

The initial grain size is 310 nm.

The powder consists of practically spherical particles with small agglomerates with a size comprised between 1 μm and 5 μm.

The developed surface area of the powder is estimated to be 14 m²/g.

The operation lasts for 35 minutes before the dispersion is diluted twice with de-ionized water, and 6 g of alginate are added as a powder inside the vortex.

The alginate is the commercial alginate made by CIMAPREM®.

The grade, or quality used is CIMALGIN® 80/400.

The grain size of the alginate powder is comprised between 100 μm and 300 μm.

The additional frequency is 200 mg/min for 30 minutes.

The self-assembling into grape bunches is accomplished during this step.

The stirring at 2,000 rpm is maintained while it is proceeded with the emptying of the solution, the total volume of which is 1 liter.

The emptying is carried out drop wise in liquid nitrogen.

The practically instantaneous freezing of the solution drops sets the grape bunch organization.

The self-assembling of the silicon nanoparticles on the network of CNTs is carried out during freeze-drying of the ice “drops”.

The conditions of the freeze-drying are a temperature of −90° C. with a vacuum of 0.002 mbars.

The duration of this operation is 8 hours.

The electron conduction and the stiffening of the self-assembly into grape bunches is carried out by carbonization of the freeze-dried powder.

To do this, the freeze-dried powder is placed in quartz crucibles, and two primary vacuum cycles are carried out in a horizontal oven, with successive fillings of 2% hydrogenated argon.

The temperature cycle is a rise in temperature from room temperature up to 600° C. at a rate of 20° C./min, followed by a plateau at 600° C. for one hour.

### Example 2

In this example, a negative electrode is prepared with the composite material according to the invention prepared in Example 1.

One begins by preparing an ink comprising 1.5 g of the composite material according to the invention prepared in Example 1 and a carrier consisting of 1.875 g of an aqueous 8% alginate hydrogel corresponding to 0.15 g of alginate.

The alginate is a commercial product from CIMAPREM® with reference CIMALGIN500®.

The alginate gel is obtained by extrusion in a twin-screw extruder (Prism® Extruder) with 100 g of alginate for 1,250 g of water. Such an extrusion method was retained since it allows maximization of the entanglements.

1.5 g of the self-assembled powder prepared in Example 1 are incorporated into 1.875 g of alginate gel prepared beforehand by extrusion (92% of water and 8% by mass of alginate extruded previously), in order to prepare an ink.

The incorporation of the powder into the alginate gel is carried out by a mixing technique without any milling, in a mixing device therefore not causing any milling.

Indeed, this incorporation operation is not a milling operation, since the energy set into play is very low, i.e. below 125 J/revolution in order to preserve the nanostructure formed by the self-assembling of the carbon nanotubes with the silicon nanoparticles and a scale of less than 10 μm.

The mixing device used gives the possibility of avoiding lumps, and gives the possibility of retaining an ink fineness of less than 10 μm.

It is therefore possible with this technique and this device, to intimately mix the self-assembled powder of carbon nanotubes and the silicon nanoparticles with its carrier, i.e. the alginate gel, by adjusting the viscosity with DI (de-ionized) water so as to attain the value of 1 Pa·s at a shear rate of 1 s⁻¹ and a grain size fineness of less than 10 μm.

Once the homogenization of the self-assembled powder according to the invention and of the alginate gel has been carried out, 0.225 g of carbon fibers VGCF® ( [symbol] Vapor Grown Carbon Fibers [symbol] ) from SHOWA DENKO, are incorporated into the ink with the same technique and the same device as those described earlier, by adjusting the viscosity to 1 Pa·s at a shear rate of 1 s⁻¹.

The carbon fibers VGCF® manufactured by SHOWA DENKO have diameters of 150 nm with lengths comprised between 10 μm and 20 μm. The electric resistivity of these fibers is 10⁻⁴ Ω·cm

The carbon fibers VGCF® are used as an electron conductor in addition to the carbon nanotubes.

Indeed, if inside each bunch with a size of less than 10 μm, there already exists intrinsic electron conductivity due to CNTs, it is necessary to generate long distance electron conductivity, i.e. beyond 10 μm, between each bunch.

The carbon fibers VGCF® give the possibility of electronically connecting the bunch structure and providing long distance conductivity of 10⁻⁴ Ω·cm.

This ink is then coated on a copper current collector with a thickness of 100 μm with a basis weight of 2 mg/cm² and dried at room temperature thereby forming an electrode.

The current collector coated with the dried ink layer is then heat-treated at 600° C. for 30 minutes with sweeping of hydrogenated (2%) argon in order to transform the alginate into amorphous carbon. The mass loss does not exceed 30%, which is a low value guaranteeing good cohesion of the electrode and good adherence to the copper sheet.

The electrode is then cut out into discs with a diameter of 16 mm and a thickness of 150 μm, i.e. a thickness of 100 μm of ink and a thickness of 50 μm of copper sheet, and these discs are treated with hydrogen plasma in order to deoxidize the silicon and etch the amorphous carbon so as to improve the accessibility of the electrolyte to the surfaces of the silicon particles.

The photographic plates of FIGS. 12 and 13 show the structure of the discs after the plasma treatment.

Each of these discs may form the negative electrode of a button battery.

FIG. 17 also shows the structure of the electrode according to the invention in which the carbon nanotubes and the silicon nanoparticles have a grape bunch organization.

### Example 3

In this example, the negative electrode prepared in Example 2 is tested in a lithium metal battery (half-battery test) of the button battery type.

Each button battery is mounted by carefully observing the same procedure.

Are thus stacked from the bottom of the casing of the battery, as this is shown in FIG. 14:
a negative electrode according to the invention (diameter of 16 mm, thickness 100 μm) (101) deposited on a copper disc being used as a current collector with a thickness of 50 μm;
150 μL of liquid electrolyte based on LPF₆ salt in amount from 1 mol/L, in solution in a 1/1 mixture by mass of ethylene carbonate and dimethyl carbonate, but any other liquid non-aqueous electrolyte known in the art may be used;
the electrolyte impregnates a separator which is a microporous membrane in polyolefin, more specifically, a microporous membrane made of polypropylene Celgard® (102)Ø16.5 mm;
a positive electrode (103) consisting of a disc with a diameter of 14 mm made of lithium metal;
a disc or shim in stainless steel (104);
a stainless steel lid (105) and a stainless steel bottom (106);
a stainless steel spring (107) and a polypropylene gasket (108).

The stainless steel casing is then closed by means of a crimping machine, making it perfectly airproof.

In order to check whether the batteries are operational, the latter are checked by measuring the floating voltage.

Because of the strong reactivity of lithium and of its salts to oxygen and water, their introduction into the button battery is accomplished in a glove box. The latter is maintained with slight overpressure under an anhydrous argon atmosphere. Sensors give the possibility of continuously monitoring the oxygen and water concentration. Typically, these concentrations should remain less than 1 ppm.

The button battery prepared according to the procedure described above is subject to cyclings, i.e. charging and discharging cycles at different constant current conditions, for a determined number of cycles, in order to evaluate the practical capacity of the battery. For example, a battery which is charged under C/20 conditions is a battery to which a constant current is imposed for 20 hours with the purpose of recovering all its capacity C. The value of the current is equal to the capacity C divided by the number of charging hours i.e. in this case 20 hours. The capacity is 8.5 mAh. The formation at room temperature is carried out at C/20 for 5 hours and at C/10 up to 4.2 V. After this step, [symbol] floating [symbol] is carried out at C/100 before resting for 5 minutes. The formation ends with a pre-charging at C/5 up to 2.5V. The cycling is at 20° C. at C/20 at 100% of the capacity. The results of this cyclability test conducted with an electrode according to the invention are plotted on the graph of FIG. 15 (▪).

### Example 4

In this example, a negative electrode prepared with a material prepared from a statistical dispersion of carbon nanotubes and of silicon nanoparticles is tested.

1.25 g of carbon nanotubes are weighed in a 100 ml beaker.

The carbon nanotubes are commercial nanotubes, available from Arkema under the name of Graphistrength®.

These nanotubes are multi-wall nanotubes with a purity of more than 90%, with an average diameter comprised between 10 nm and 15 nm, and an average length of 7 μm.

The specific surface area of these nanotubes is comprised between 20 m²/g and 70 m²/g.

The initial grain size is comprised between 10 μm and 100 μm, in majority as entangled nanotubes and forming agglomerated balls.

In this same beaker, are successively added 0.7 g of alginate as a powder, and 20 mL of de-ionized water.

The whole is subject to the action of ultrasonic waves for 15 minutes.

Next, 8.75 g of a commercial silicon powder Stile® are added.

The initial grain size is 310 nm and it consists of practically spherical particles with small agglomerates with a size comprised between 1 μm and 5 μm.

The developed surface area is estimated to be 14 m²/g.

20 ml of de-ionized water are added before deagglomeration by the ultrasonic waves of the assembly.

The statistical mixture between the CNTs and the silicon is achieved by ultrasonic waves and lasts for 30 minutes.

In order to end the preparation of the ink, 0.8 g of alginate as a powder are added with 0.225 g of carbon fibers VGCF® which come from SHOWA DENKO. These carbon fibers VGCF® have diameters of 150 nm and lengths comprised between 10 μm and 20 μm. The electric resistivity is 10⁻⁴ Ω·cm.

The ink is mixed with the high-rate mixer of the Ultra-Turrax® type at a frequency rotation of 2.000 rpm for 15 min.

Next, 5 ml of latex of the Ardex® 301 brand are added to the ink. Next, the ink is deposited at a rate of 20 ml/min on a 12 μm copper collector. Drying is carried out at room temperature, and then it is proceeded with drying in the oven at 100° C. for 24 hours.

The thereby prepared electrode is then punched to a diameter of 14 mm before being mounted in a lithium metal battery (half-battery test) of the button battery type prepared like in Example 3.

FIG. 16 shows the structure of this electrode according to the prior art prepared from a random dispersion of carbon nanotubes and of silicon nanoparticles and which therefore does not have the grape bunch structure according to the invention.

The formation and the cycling are accomplished under the same conditions as in Example 3.

The results of this cyclability test conducted with an electrode representing the prior art are plotted on the graph of FIG. 15 (♦).

From the graph of FIG. 15 it becomes apparent that the accumulator which comprises an electrode according to the invention has a discharge capacity of about 2,400 mAh/g while the accumulator which comprises an electrode according to the prior art has a discharge capacity of less than 1,500 mAh/g, and in this example 900 mAh/g.

1. A nanocomposite material comprising nano-objects made of at least one first electron conducting material and nano-objects or submicron objects made of at least one second material different from the first material; said nanocomposite material comprising nanostructures each consisting of a three-dimensional network consisting of the nano-objects made of at least one first electronic conducting material bound and maintained by a polysaccharide, the nano-objects or the submicron objects made of at least one second material different from the first material being self-assembled around said network and being attached to the nano-objects made of at least one first electron conducting material by said polysaccharide, and said nanostructures being homogenously distributed in the material.

2. The material according to claim 1, wherein each of the nanostructures has a size which is at least equal to the size of each of the nano-objects made of at least one first electron conducting material.

3. The material according to claim 1, wherein the first electron conducting material is selected from carbon, metals such as aluminium and copper, and metal alloys such as aluminium alloys and copper alloys.

4. The material according to claim 1, wherein the second material is selected from silicon; metals like tin; metal alloys; sulphur, metal oxides such as alumina; active materials of a positive electrode of lithium ion accumulators such as LiFePO₄, LiFeSO₄F, LiCoO₂, LiNiO₂, LiFeₓMn_{y}PO₄, LiMnₓNi_{y}O₄, LiMnₓNi_{y}Nb_{z}O₄, LiNiₓMn_{y}Al_{z}O₂, LiCoₓNi_{y}Mn_{z}O₂, titanium phosphates, Li₂CoSiO₄, LiMnₓO₄, LiNiₓPO₄, LiCoₓO₂, LiNiₓCo_{y}O₂, sodium, vanadium oxide, TiS₂, TiOₓS_{z}, Li₂MnO₃; and the active materials of a negative electrode of lithium ion accumulators such as graphite, titanates like Li₄Ti₅O₁₂, H₂Ti₁₂O₂₅, Si, Sn, niobium oxides LiₓNb_{y}O_{z}, VBO₃, TiSnSb, Li₂SnO₃, Ni—Si, TiO₂, and SnCo.

5. The material according to claim 1, wherein the nano-objects made of at least one first material are selected from nanotubes, nanowires, nanofibers, nanoparticles, nanocrystals made of at least one first material, and mixtures thereof; and the nano-objects or submicron objects made of at least one second material are selected from nanotubes, nanowires, nanofibers, nanoparticles, submicron particles, nanocrystals made of at least one second material, and mixtures thereof.

6. The material according to claim 1, wherein the first material is carbon, and the second material is a material other than carbon such as silicon.

7. The material according to claim 6, wherein the carbon nano-objects are selected from carbon nanotubes and carbon nanofibers; and the nano-objects or submicron objects made of at least one material other than carbon are silicon nanoparticles or silicon submicron particles.

8. The material according to claim 7, wherein the carbon nanotubes are selected from single-walled carbon nanotubes, and multi-walled carbon nanotubes such as double-walled carbon nanotubes.

9. The material according to claim 6, wherein the nano-objects or the submicron objects in at least one material other than carbon, such as silicon nanoparticles or silicon submicron particles have a spherical or spheroidal shape.

10. The material according to claim 1, wherein the first material is aluminium or copper, and the second material is a material other than aluminium or copper such as silicon.

11. The material according to claim 1, wherein the ratio of the number of nano-objects or submicron objects made of at least one second material, for example made of silicon, to the number of nano-objects made of at least one first material, for example made of carbon, such as carbon nanotubes, is less than or equal to 1/100.

12. The material according to claim 1, wherein the polysaccharide is selected from pectins, alginates, alginic acid and carrageenans.

13. The material according to claim 1, which appears as a powder notably an expanded powder.

14. The material according to claim 13, wherein the powder has an average grain size comprised between 1 μm and 100 μm, a specific surface area comprised between 10 m²/g and 50 m²/g, and a density comprised between 2.014 g/cm³ and 2.225 g/cm³.

15. The material obtained by carbonization of the material according to claim 1, and transformation of the polysaccharide into amorphous carbon.

16. A method for preparing the nanocomposite material according to claim 1, wherein the following successive steps are carried out:
a) the nano-objects made of at least one first material are put into contact with water, and then the nano-objects made of at least one first material are mixed with water by using the succession, optionally repeated, of a mixing technique with ultrasonic waves and then of a high rate mixing technique, the mixture of nano-objects made of an at least one first material and water being maintained in circulation, for example by a pump, so as to avoid that the nano-objects made of at least one first material agglomerate, whereby a dispersion consisting of the nano-objects made of at least one first material and of water is obtained, and said dispersion is maintained in circulation;
b) without interrupting the circulation of the dispersion, mixing with ultrasonic wave is stopped and the nano-objects or the submicron objects made of at least one second material are mixed with the dispersion consisting of the nano-objects made of at least one first material and of water, by using a high rate mixing technique, whereby a dispersion consisting of the nano-objects made of at least one first material, of the nano-objects or submicron objects made of at least one second material, and of water is obtained, and said dispersion is maintained in circulation;
c) without interrupting the circulation of the dispersion, at least one polysaccharide is added at a constant rate, and is gradually dissolved in the dispersion consisting of the nano-objects made of at least one first material, of the nano-objects or the submicron objects made of at least one second material, and of water, and the polysaccharide is mixed with the dispersion by using a high rate mixing technique, whereby a dispersion is obtained in which nanostructures each consisting of a three-dimensional network consisting of the nano-objects made of at least one first material bound and maintained by a hydrogel of the polysaccharide, the nano-objects or the submicron objects made of at least one second material being self-assembled around said network and being attached to the nano-objects made of at least one first material by said hydrogel of the polysaccharide, are homogenously distributed;
d) the dispersion prepared in step c) is frozen, and then the ice is sublimated whereby the nanocomposite material is obtained.

17. The method according to claim 16, wherein the concentration of the nano-objects made of a first material, for example carbon nano-objects, in the dispersion of step a) is from 1 to 5 g/L of water, for example 2.5 g/L of water.

18. The method according to claim 16, wherein, during step a) the energy provided by the ultrasonic waves does not exceed 5 joules.

19. The method according to claim 16, wherein the concentration of the nano-objects or of the submicron objects made of at least one second material in the dispersion of step b) is from 5 to 15 g/L of dispersion, for example 10 g/L of dispersion.

20. The method according to claim 16, wherein the concentration of the polysaccharide in the dispersion of step c) is from 1 to 6 g/L of dispersion.

21. An ink comprising the composite material according to claim 1, and a carrier.

22. The ink according to claim 21, further comprising at least one electron conductor.

23. An electrode comprising as an electrochemically active material the composite material according to claim 15.

24. The electrode according to claim 23, which is a negative electrode.

25. An electrochemical system comprising an electrode according to claim 23.

26. The electrochemical system according to claim 25, which is a non-aqueous electrolyte system such as a rechargeable electrochemical battery with a non-aqueous electrolyte.

27. The electrochemical system according to claim 26, which is a lithium ion battery.
